(19) United States
(12) Patent Application Publication
(10) Pub. No.: US 2025/0058581 A1
(43) Pub. Date: Feb. 20, 2025

(54) METHOD FOR PRODUCING A WORKPIECE

(71) Applicant: HOMAG GmbH, Schopfloch (DE)

(72) Inventors: Alija HODZA, Freudenstadt (DE); Patrick MÜLLER, Glatten (DE)

(21) Appl. No.: 18/719,241

(22) PCT Filed: Dec. 13, 2022
(86) PCT No.: PCT/EP2022/085541

§ 371 Date: Jun. 12, 2024

(30) Foreign Application Priority Data
Dec. 14, 2021 (DE) 10 2021 133 043.2

(51) Int. Cl. B44C 1/10; B27D 5/00; B41J 3/407

(52) U.S. Cl. CPC B44C 1/10; B27D 5/003; B27D 5/006; B41J 3/407

(57) ABSTRACT

The present disclosure relates to a method for producing a plate-shaped workpiece. The method can include providing a plate-shaped raw workpiece, dividing up the raw workpiece to form one or more workpieces, applying a strip-shaped coating material to one or more narrow surfaces of the at least one workpiece, and machining the at least one workpiece. The method can be performed such that at least one wide surface is printed in a first digital printing process and at least one narrow surface provided with the strip-shaped coating material is printed in a second digital printing process. Further, the first and second printing processes can be performed after division of the raw workpiece.

### TECHNICAL FIELD

The invention relates to a method for producing a workpiece, said workpiece in particular being formed at least in sections from wood or a wood material such as chipboard or fibreboard (MDF, HDF). A processing and handling system is also provided.

### PRIOR ART

During the processing of workpieces for the furniture industry (living room, bathroom and kitchen furniture) as well as for the panel industry in general, current value-adding processes provide for the application of a decorative pattern to the wide surfaces thereof. The raw workpiece (large-format plate) is either already provided with a decorative pattern during production or the decorative pattern is formed on the raw workpiece by means of a printing process. In the case of the indirect gravure printing process (liquid coating with rollers), this can take place during production of the large-format plates, with these large-format plates only later being cut into different standard sizes for the plate market or being cut in accordance with specific orders for end products.

In this approach, a strip-shaped coating material (also known as an “edge band”) is accordingly applied to the workpiece after printing the raw workpiece. However, inter alia the colour thereof must be adapted to the printed decorative pattern.

The corresponding workpieces with the desired decorative pattern on the top and bottom sides as well as the corresponding matching edge band must therefore be provided and stored for production on the machines. Furthermore, residual materials (carrier plate, edge bands) occur after the processing steps, which may possibly not be reusable and must therefore either be stored or disposed of.

In other wide-surface lamination processes, film-shaped half-formats (decorative finishing films, i.e. thermoplastic films made of PVC, PP, PET, laminates, HPL, CPL or even veneers) containing the decorative pattern are applied to the carrier plate (MDF, HDF, chipboard) by means of a binding agent (adhesives: UF or UMF resin glues, PVAc or EVA dispersion adhesives, hot-melt adhesives). These processes also require suitable edge bands to be kept in stock for production.

### DESCRIPTION OF THE INVENTION

The invention is based on the object of providing a method with which a production process can be configured to be more flexible and at the same time of high quality.

The subject matter of claim 1 provides such a method. Further preferred embodiments are specified in the dependent claims and described below.

In particular provided is a method for producing a plate-shaped workpiece comprising the steps of: Providing a plate-shaped raw workpiece, in particular a large-format plate, dividing up the raw workpiece to form one or more workpieces, applying a strip-shaped coating material to one or more narrow surfaces of the at least one workpiece, and machining the at least one workpiece. In the course of the method, at least one wide surface is printed in a first digital printing process and at least one narrow surface provided with the strip-shaped coating material is printed in a second digital printing process, the first and second printing processes being performed after division of the raw workpiece.

A strip-shaped coating material may in particular be made from a plastic material or comprise a veneer.

The method according to the invention is characterised in that printing of the wide surfaces (top and bottom sides) of the workpiece and printing of the strip-shaped coating material with an (individual) decorative pattern in the digital printing process is performed during processing of the workpiece obtained from a raw workpiece. Variance and complexity are therefore shifted to a later stage of the manufacturing process, and thus individual customer requirements are not introduced until this stage. As a result of the printing then performed as part of the digital printing process, drilling, as an example of machining, can thereby be protected against subsequent external influences such as moisture, wetness and other damage during transport, storage and final use at the end customer. This approach additionally reduces the visibility of the effects of machining, for example bore holes, and thus improves the overall appearance of the workpiece.

Printing of the wide surface in a first digital printing process can take place before, during or after printing of the narrow surface in a second digital printing process. However, it is particularly preferred that printing of the wide surface in a first digital printing process takes place after printing of the narrow surface in a second digital printing process.

The method according to the invention also has the advantage that the decorative patterns of the wide surface(s) and the narrow surface(s) match. Individual customer requirements can furthermore be met without increasing the variance of the workpiece or the strip-shaped coating materials. This leads to a reduction of the complexity in the production process and in material handling.

The stock of residual materials can also be significantly reduced since only single-colour workpieces and/or single-colour, strip-shaped coating materials have to be kept in stock. This reduces the general organisational effort, and customer requirements can be met without longer delivery times and, if necessary, can also be changed at short notice.

The quality of the workpieces is furthermore achieved by coating and sealing the machined sections (in particular bore holes).

The following steps may be carried out as part of digital printing, a digital printing process or a digital printing method, preferably in the specified order: Applying a primer/adhesive base coat to the surface to be printed in order to create and/or improve the adhesive properties, printing a surface by means of a digital printer, in particular an ink jet printing device, and sealing/protecting/finishing the then already printed surface with a coating in order to protect it against external influences such as UV radiation, abrasion, scratches or impacts. These latter coatings may be applied by means of a roller or spray coating process or by means of an ink jet process.

According to one embodiment, a visually and/or haptically perceptible surface is provided in the course of the first and second digital printing processes. The digital printing device may in particular be configured to print a graphic pattern, image or the like on a surface and, if necessary, to additionally provide it with a structured surface/haptically perceptible structure.

The method may furthermore include the step of finalising production, in particular mounting attachment parts to the workpiece, packaging the workpiece and/or preparing the workpiece for dispatch.

It is preferred that the first and second digital printing processes are performed between two of the aforementioned steps, in particular one after the other or in parallel.

It is preferred that the first digital printing process, during which a wide surface of a workpiece is printed, is performed during or after the second digital printing process. This thus enables extremely precise printing. Even if overspray were to occur when printing the narrow surface of the workpiece, the resulting contamination on the wide surface could be corrected by printing during the first digital printing process. This is particularly advantageous since the wide surface is often the main visible side.

It is preferred that dividing up of the raw workpiece is carried out using a saw. A high throughput can thus be achieved with low material loss. Once the raw workpiece has been divided up into a plurality of workpieces, these can be separated before further processing.

It is furthermore preferred that the machining step includes the introduction of a bore, in particular into a wide surface and/or a narrow surface of the workpiece.

The first and second digital printing processes can be performed after the step of applying the coating material. The printing processes are thus at a relatively late stage of the production process, ensuring a high degree of flexibility.

According to a preferred embodiment, it is provided that the application of strip-shaped coating materials takes place in several passes. This reduces the complexity of a corresponding coating device.

It is furthermore preferred that the first digital printing process and the second digital printing process are performed after the step of machining the at least one workpiece. The machined sections, in particular the already drilled bore(s), can therefore be closed and sealed by the surface finish of the digital printing process.

It is preferred that the steps are carried out along a conveyor line. The stations at which the aforementioned steps are carried out may be connected by means of transport devices.

The invention further provides a processing and handling system, which is in particular configured to carry out the method according to one of the aforementioned aspects.

The processing and handling system in particular comprises a device for applying a strip-shaped coating material to one or more narrow surfaces of the at least one workpiece, a device for carrying out machining on the at least one workpiece, and a first digital printing device for performing a first digital printing process for printing a wide surface of the workpiece and a second digital printing device for performing a second digital printing process on a narrow surface of the workpiece provided with the strip-shaped coating material.

According to one embodiment, the device for applying a strip-shaped coating material and the device for carrying out machining are arranged one after the other in a throughput direction, preferably in the cited order.

It is preferred that the first digital printing device and the second digital printing device are configured to provide a visually and/or haptically perceptible surface. For example, a graphic pattern, an image or the like and possibly a textured surface may be printed.

It may furthermore be provided that the first digital printing device and the second digital printing device are arranged in a throughput direction downstream of the device for applying a strip-shaped coating material, in particular downstream of the device for performing machining.

### BRIEF DESCRIPTION OF THE DRAWINGS

Further features and advantages are apparent from the following description of embodiments with reference to the accompanying figures.

FIG. 1 shows a method sequence according to a first embodiment of the invention.

FIG. 2 shows a method sequence according to a second embodiment of the invention.

FIG. 3 shows a method sequence according to a third embodiment of the invention.

FIG. 4 shows a method sequence according to a fourth embodiment of the invention.

### DESCRIPTION OF EMBODIMENTS

Identical reference numbers used in different figures designate identical, corresponding or functionally similar elements.

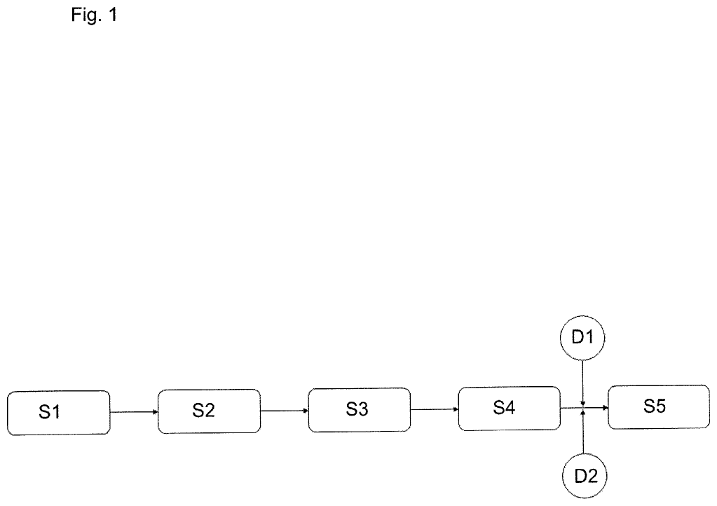

FIG. 1 shows a method sequence according to a first embodiment. Within the framework of the method, a workpiece is produced from a plate-shaped raw workpiece and this workpiece is prepared for dispatch. A processing and handling system is used in this regard, with which the plate-shaped raw workpiece can be moved, divided into workpieces and the workpieces can be subsequently processed. The processing and handling system can be formed by stations connected by transport sections, or a workpiece can move from station to station via a conveying mechanism such as a trolley, crane or robot.

The raw workpiece and the workpieces obtained from a raw workpiece are in particular made from wood or wood materials, such as kitchen worktops, furniture fronts, removable shelves, flooring or the like. For example, a workpiece made of a wood material may be a chipboard or fibreboard (MDF, HDF, etc.). The plate-shaped workpieces have two wide surfaces (top and bottom sides) and a plurality of narrow surfaces. In the case of a rectangular workpiece, there are four narrow surfaces.

A raw workpiece is provided at the start of the production process (step S1), which is fed to the processing and handling system as a semi-finished product. The raw workpiece may be provided from a plate store, whereby raw workpieces are stacked at a feed section of the processing and handling system and fed individually to the processing and handling system.

One or more workpieces are obtained from this raw workpiece by using a dividing device (step S2), and these are then forwarded for further processing. The dividing device may in particular be a plate dividing saw.

Since the narrow surfaces are exposed owing to the use of the dividing device and since the outer narrow surfaces of the raw workpiece are not coated, a strip-shaped coating material (also called an “edge band”) is applied to the respective narrow surfaces of the workpiece in a further step (step S3). The coating materials can be applied to the various narrow surfaces of the workpiece in one or more passes. The application of a strip-shaped coating material using various coating techniques is described, for example, in the document EP 2 243 619 A1.

After the coating material has been applied, machining of the workpiece, in particular drilling and/or milling, is carried out (step S4). According to the embodiment example described here, bore holes for mounting attachment parts, such as hinges, or for fixing to another workpiece are formed in the course thereof. At least one of the bore holes has an opening in the wide surface or narrow surface of the workpiece.

Within the framework of the method, a first digital printing process D1 (hereinafter also simply referred to as the first “printing process”) and a second digital printing process D2 (hereinafter also simply referred to as the second “printing process”) are performed using a respective ink jet printing device.

In the first printing process D1, the wide surfaces of the workpiece are printed (top and bottom sides of the workpiece). Such printing using an ink jet printing device can be carried out over the entire surface, whereby the printing area is set so as to avoid so-called overspray in the edge area of the wide surface. A visually and/or haptically perceptible surface is provided by a printing process.

In the course of the second printing process D2, which is performed before, during or after the first printing process D1, the narrow surfaces of the plate-shaped workpiece are printed. It is particularly preferred that the second printing process D2, with which the narrow surface is printed, is performed before the first printing process (printing of the wide surface). A visually and/or haptically perceptible surface is also provided in the course of the second printing process.

At least the narrow surfaces that are aligned in a throughput direction can be printed in one pass. The narrow surfaces that are aligned transverse to the throughput direction, i.e. the front and rear narrow surfaces in the case of a rectangular workpiece, can be printed in a further pass after the workpiece has been rotated about an axis extending in the vertical direction.

After the first printing process D1 and the second printing process D2 have been carried out, further attachment parts are mounted on the workpiece, the workpiece is packaged and prepared for dispatch (step S5). This finalises the production process.

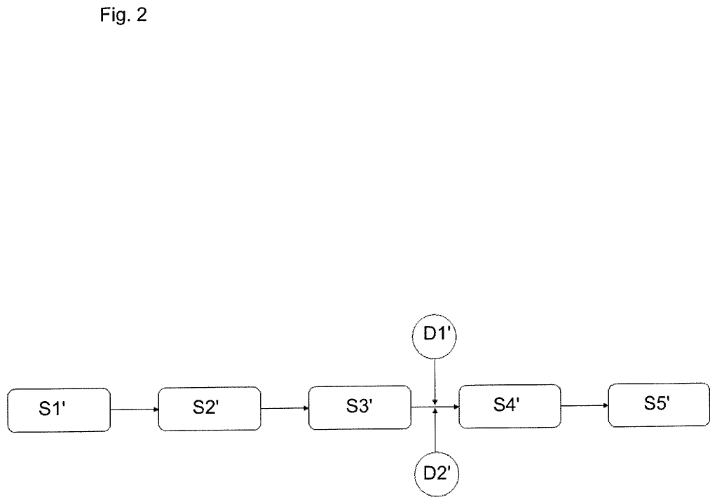

FIG. 2 shows a method according to a second embodiment which, similar to the method according to the first embodiment, comprises providing a raw workpiece (step S1′), dividing up the raw workpiece (step S2′), applying a coating material (step S3′) and machining (step S4′). The machining of the workpiece (step S4′) is followed by the step of assembling, packaging and dispatching the workpiece (step S5′).

A first printing process D1′ and a second printing process D2′ are also carried out with a respective ink jet printing device within the framework of the method according to the second embodiment, the wide surfaces of the workpiece being printed in the first printing process D1′ and the narrow surfaces of the workpiece being printed in the second printing process D2′. The second printing process D2′ can be performed before, during or after the first printing process D1′.

However, the timings of the printing processes D1′, D2′ differ from those of the first embodiment. In particular, the first printing process D1′ and the second printing process D2′ are performed between the step of applying the coating material (step S3′) and the machining step (step S4′).

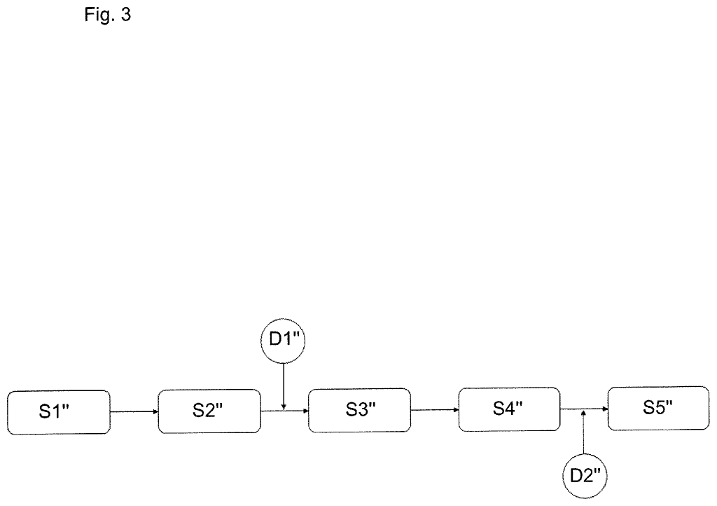

FIG. 3 shows a method according to a third embodiment which, similar to the method according to the first or second embodiment, comprises providing a raw workpiece (step S1″), dividing up the raw workpiece (step S2″), applying a coating material (step S3″) and machining (step S4″). After machining (step S4″), the workpiece is assembled, packaged and dispatched (step S5″).

A first printing process D1″ and a second printing process D2″ are carried out with a respective ink jet printing device in the method according to the third embodiment, the wide surfaces of the workpiece being printed in the first printing process D1″ and the narrow surfaces of the workpiece being printed in the second printing process D2″.

In contrast to the embodiments described above, the first printing process D1″ is performed after division of the raw workpiece (step S2″), but before application of a coating material (step S3″). The second printing process D2″ is performed after machining (step S4″) and before step S5″.

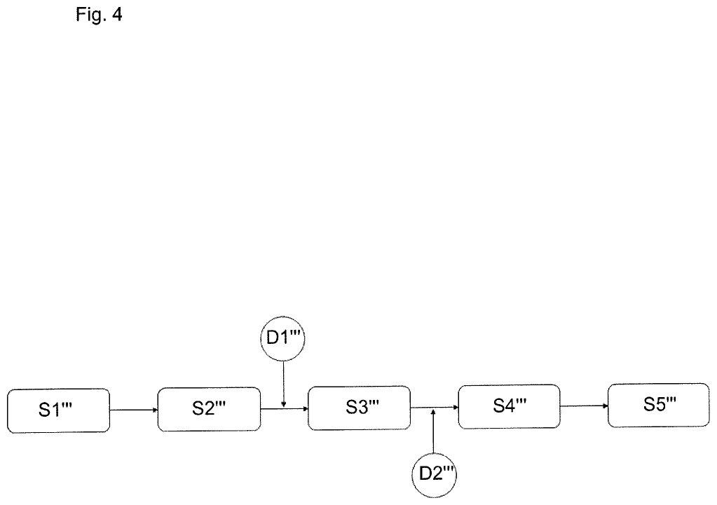

FIG. 4 shows a method according to a fourth embodiment, the method according to a fourth embodiment, similar to the method according to the first to third embodiments, comprising providing a raw workpiece (step S1′″), dividing up the raw workpiece (step S2′″), applying a coating material (step S3′″) and machining (step S4″″). After machining (step S4′″), the workpiece is assembled, packaged and dispatched (step S5′″).

A first printing process D1′″ and a second printing process D2′″ are carried out with a respective ink jet printing device in the method according to the fourth embodiment, the wide surfaces of the workpiece being printed in the first printing process D1′″ and the narrow surfaces of the workpiece being printed in the second printing process D2′″. However, according to the fourth embodiment, the first printing process D1′″ is performed before the second printing process D2′″. The first printing process D1′″ in particular takes place after division of the raw workpiece (step S2′″) and before application of a coating material (step S3′″). The second printing process D2′″ is performed after the application of a coating material (step S3′″) and before machining (step S4′″).

It is apparent to the person skilled in the art that individual features described in different embodiments can also be implemented in a single embodiment, provided that they are not structurally incompatible. Similarly, various features described in the context of a single embodiment may also be provided in several embodiments either individually or in any suitable sub-combination.

1. A method for producing a plate-shaped workpiece, the method comprising the steps of:
providing a plate-shaped raw workpiece;
dividing up the raw workpiece to form at least one workpiece;
applying a strip-shaped coating material to one or more narrow surfaces of the at least one workpiece;
machining the at least one workpiece;
after the dividing, via a first digital printing process, printing onto at least one wide surface; and
after the dividing, via a second digital printing process, printing onto at least one narrow surface of the strip-shaped coating material.

2. The method according to claim 1, wherein the first or second digital printing process comprises:
applying an adhesive base coat to the at least one wide surface or the at least one narrow surface in order to create or improve adhesive properties thereof; and
sealing the at least one wide surface or the at least one narrow surface with a coating after the printing.

3. The method according to claim 1, wherein a visually or haptically perceptible surface is provided by the first and second digital printing processes.

4. The method according to claim 1, further comprising the step of finalising production, in particular by mounting attachment parts to the workpiece, packaging the workpiece or preparing the workpiece for dispatch.

5. The method according to claim 1, wherein the first and second digital printing processes are performed between two of said steps.

6. The method according to claim 1, wherein the first digital printing process is performed during or after the second digital printing process.

7. The method according to claim 1, wherein the dividing is performed using a saw.

8. The method according to claim 1, wherein the machining comprises introducing a bore into a wide surface or a narrow surface of the workpiece.

9. The method according to claim 1, wherein the applying is performed in several passes.

10. The method according to claim 1, wherein the first and second digital printing processes are performed after the step of applying the coating material.

11. The method according to claim 1, wherein the first digital printing process and the second digital printing process are performed after the machining.

12. The method according to claim 1, wherein the steps are carried out along a conveyor line.

13. A processing and handling system comprising:
a device for applying a strip-shaped coating material to one or more narrow surfaces of at least one workpiece;
a device for machining the at least one workpiece;
a first digital printing device for performing a first digital printing process for printing a wide surface of the workpiece; and
a second digital printing device for performing a second digital printing process on a narrow surface of the workpiece provided with the strip-shaped coating material.

14. The processing and handling system according to claim 13, wherein the first digital printing device and the second digital printing device are configured to provide a visually or haptically perceptible surface.

15. The processing and handling system according to claim 13, wherein the first digital printing device and the second digital printing device are arranged in a throughput direction downstream of the device for applying a strip-shaped coating material downstream of the device for performing machining.
